(19) United States
(12) Patent Application Publication
(10) Pub. No.: US 2012/0209998 A1
(43) Pub. Date: Aug. 16, 2012

(54) METHOD AND APPARATUS FOR PROVIDING ACCESS TO SOCIAL CONTENT BASED ON MEMBERSHIP ACTIVITY

(75) Inventors: Bror Lennart Svarfvar, Kaarina (FI); Jakke Sakari Makela, Turku (FI); Terho Otso Tapio Kaikuranta, Kaarina (FI)

(73) Assignee: Nokia Corporation

(21) Appl. No.: 13/025,826

(22) Filed: Feb. 11, 2011

(51) Int. Cl. G06F 15/173

(52) U.S. Cl. 709/225

(57) ABSTRACT

A method for providing access to social content based on membership activity may include receiving information providing corresponding identities of a plurality of members of a group and receiving an indication of a presence threshold defining a number of members of the group that when present enables access to a group related function. The presence threshold may be defined relative to an entirety of a size of the group. The method may further include modifying the presence threshold to determine a quorum value of members that when present enables access to the group related function where the quorum value is determined based on activity of the members of the group over at least a defined time period, and enabling access to the group related function by the members based on presence information related to the members indicating that the quorum value is met. A corresponding apparatus and computer program product are also provided.

### TECHNOLOGICAL FIELD

Embodiments of the present invention relate generally to content sharing technology and, more particularly, relate to a method and apparatus for providing access to social content based on membership activity.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. One area in which there is a demand to increase ease of information transfer relates to the sharing of information between multiple devices and potentially between multiple users. In this regard, given the ability for modern electronic devices to create and modify content, and also to distribute or share content, it is not uncommon for users of such devices to become prolific users and producers of media content. Networks and services have been developed to enable users to move created content to various points within the networks.

Various applications and software have also been developed and continue to be developed in order to give the users robust capabilities to perform tasks, communicate, obtain information or services, entertain themselves, etc. in either fixed or mobile environments. Given the robust capabilities of mobile electronic devices and the relatively small size of such devices, it is becoming increasingly common for individuals to keep mobile electronic devices on or near their person on a nearly continuous basis. Moreover, because such devices are useful for work, play, leisure, entertainment, and other purposes, many users also interact with their devices on a frequent basis. Accordingly, whether interaction occurs via a mobile electronic device or a fixed electronic device (e.g., a personal computer (PC)), more and more people are interacting with friends, colleagues and acquaintances via online networks. This trend has led to the rise of a number of social networking applications that span the entire spectrum of human interaction from purely professional to purely leisure activities and everything in between.

Users of social networking applications often use the social network as a mechanism by which to distribute content to others. In some cases, content may be freely shared without any access restrictions. However, in other situations, content distribution may be limited to a specific set of other users, friends, or colleagues. Limiting access to content may sometimes be accomplished by employing user IDs and/or passwords that are manually entered when logging into a system or web site. Various types of digital rights management (DRM) techniques have also been developed, particularly for managing access to commercial content. However, it may be desirable to develop yet further mechanisms by which to enable access to content that is desirable for sharing under specific and/or controllable circumstances.

### BRIEF SUMMARY

A method, apparatus and computer program product are therefore provided for enabling the provision of access to social content based on membership activity. In this regard, for example, some embodiments of the present invention may enable the employment of presence information regarding members of a social group as an enabling factor with respect to providing access to content. Furthermore, some embodiments may provide for consideration of membership activity of the members of the group with respect to determination of whether a quorum of members is present.

In one example embodiment, a method of providing access to social content based on membership activity is provided. The method may include receiving information providing corresponding identities of a plurality of members of a group and receiving an indication of a presence threshold defining a number of members of the group that when present enables access to a group related function. The presence threshold may be defined relative to an entirety of a size of the group. The method may further include modifying the presence threshold to determine a quorum value of members that when present enables access to the group related function where the quorum value is determined based on activity of the members of the group over at least a defined time period, and enabling access to the group related function by the members based on presence information related to the members indicating that the quorum value is met.

In another example embodiment, a computer program product for providing access to social content based on membership activity is provided. The computer program product includes at least one computer-readable storage medium having computer-executable program code instructions stored therein. The computer-executable program code instructions may include program code instructions for receiving information providing corresponding identities of a plurality of members of a group and receiving an indication of a presence threshold defining a number of members of the group that when present enables access to a group related function. The presence threshold may be defined relative to an entirety of a size of the group. The program code instructions may further include instructions for modifying the presence threshold to determine a quorum value of members that when present enables access to the group related function where the quorum value is determined based on activity of the members of the group over at least a defined time period, and enabling access to the group related function by the members based on presence information related to the members indicating that the quorum value is met.

In another example embodiment, an apparatus for providing access to social content based on membership activity is provided. The apparatus may include at least one processor and at least one memory including computer program code. The at least one memory and the computer program code may be configured to, with the at least one processor, cause the apparatus to perform at least receiving information providing corresponding identities of a plurality of members of a group and receiving an indication of a presence threshold defining a number of members of the group that when present enables access to a group related function. The presence threshold may be defined relative to an entirety of a size of the group. The apparatus may be further configured to perform modifying the presence threshold to determine a quorum value of members that when present enables access to the group related function where the quorum value is determined based on activity of the members of the group over at least a defined time period, and enabling access to the group related function by the members based on presence information related to the members indicating that the quorum value is met.

In another example embodiment, an apparatus for providing access to social content based on membership activity is provided. The apparatus may include means for receiving information providing corresponding identities of a plurality of members of a group and means for receiving an indication of a presence threshold defining a number of members of the group that when present enables access to a group related function. The presence threshold may be defined relative to an entirety of a size of the group. The apparatus may further include means for modifying the presence threshold to determine a quorum value of members that when present enables access to the group related function where the quorum value is determined based on activity of the members of the group over at least a defined time period, and means for enabling access to the group related function by the members based on presence information related to the members indicating that the quorum value is met.

Embodiments of the invention may provide a method, apparatus and computer program product for employment in network based content sharing environments. As a result, for example, individual device users may enjoy improved capabilities with respect to sharing content with a selected group of other device users.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a communication system according to an example embodiment of the present invention;

FIG. 2 is a schematic block diagram of an apparatus for providing access to social content based on membership activity according to an example embodiment of the present invention;

FIG. 3 illustrates a table showing an example in which a predetermined value is decremented from the membership status value of a plurality of members over a period of time due to inactivity over one or more activity reporting periods according to an example embodiment of the present invention;

FIG. 4 illustrates a sample series of active members and a corresponding number of members required to exceed the quorum value for each respective period according to an exemplary embodiment of the present invention;

FIG. 5 illustrates a block diagram pertaining to activities associated with group formation and operation according to an exemplary embodiment of the present invention; and

FIG. 6 is a block diagram according to an example method for providing access to social content based on membership activity according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a physical storage medium (e.g., volatile or non-volatile memory device), can be differentiated from a “computer-readable transmission medium,” which refers to an electromagnetic signal.

Electronic devices have been rapidly developing in relation to their communication and content sharing capabilities. As the capabilities of such devices have increased, applications and services have grown to leverage the capabilities to provide increased utility and improved experience for users. Social networks and various services and functionalities supporting social networks are examples of mechanisms developed to leverage device and network capabilities to provide users with the ability to communicate and share content with others. However, content sharing in many environments may be limited to specific situations or sets of individuals on the basis of each individual providing personal authentication information (e.g., user ID and password). However, in some settings, it may be desirable to have the presence of members of a particular group be the determining factor for granting access to certain content.

Accordingly, some embodiments of the present invention may enable content access to be provided to members of a group on the basis of the presence of a predetermined number (or all) of the members of the group (e.g., a social networking group). In cases where the predetermined number is allowed to be less than all of the membership, the predetermined number may be determined as a percentage of the total number of members. The presence may be physical presence (e.g., proximity based) or may be presence at a particular site, service or on a network. For example, presence may be determined by logging into a particular service or application that is associated with group activities and/or the location of content accessible to the group when the predetermined number of group members is met. Some example embodiments may use presence, and particularly presence of at least a predetermined number of members of the group, as a triggering mechanism to enable certain functionalities to be accessible (e.g., accessing group content or making other group related decisions). In some cases, voting of group members may be conducted to determine certain courses of action for the group or to enable certain group functionalities. In these cases, the same predetermined number of members may be used as a threshold for passage of proposals or authorization of enablement for the corresponding functionalities. Presence and/or voting may therefore be considered to be a membership activity that is indicative of active participation in the group that may enable certain functionalities if enough participation is evidenced. However, other membership activities (e.g., posting comments, sharing content, etc.) may also be used as qualifying activities to identify whether sufficient participation is evidenced (e.g., by participation of the predetermined number of members) to allow certain group decisions to be made or certain group functionalities to be enabled.

Although such measurements of group participation may be useful, it is quite common for groups to have various different levels of participation among the members of the group. For example, some members may be very active, perhaps logging in every day or numerous times per day and spending large amounts of time participating in group activities. Meanwhile, other members may rarely, or even never, log in again after their initial entry into the group. There may also be a large group of members that fall somewhere in between these two extremes. Additionally, the activity of some group members may go through different phases of high activity, moderate activity and/or low activity dependent upon the corresponding schedules and availability or interest of the group members. Given the tremendous amount of potential variability in group member activity, if there is a predetermined number of members required to enable content access or other group functions, there may be periods of time during which it is difficult or even impossible to achieve the predetermined number of participants needed to trigger group access or enable group functions.

Some example embodiments are therefore provided to give the group greater flexibility to deal with changes in participation or activity levels among group members. In this regard, for example, the predetermined number of group members (or quorum value) that is used to enable access or other group functions may not be fixed based on the total number of members of the group. Instead, for example, the quorum value may be a dynamic value that is determinable based on an assessment of recent membership activity. In some examples, the assessment of recent membership activity may include a division of membership into active and inactive segments, where only active members are used to determine the quorum value. The definitions of active and inactive members may, for example, be set based on activity within a pre-set or pre-defined time span. Thus, in various different examples, having logged in within the last day, three days, week, or month may be sufficient to maintain active member status. Meanwhile, those who have not recently logged in may be considered to be passive (or inactive) members and thus, may not count for determination of the quorum value. In other words, for example, if 80% presence is required for group decision making or group access, and 100 members are included in the group; if only 80 members are active members, then the presence of 64 members (rather than 80) would be required to enable a group decision to be passed or group access to be granted.

In another example, which may be employed as an alternative or in addition to the division of membership into active and inactive segments, decaying voting rights or decaying membership status values may be applied to members based on their activity. For example, a threshold level of activity may be required to maintain full membership status and therefore a full membership status value. As incremental time periods pass without activity, corresponding incremental decreases may be experienced in the corresponding member's membership status value. After some period, the membership status value may decrease to zero and the member may be considered to be inactive. However, with renewed activity, the membership status value may be replenished. In some examples where membership status values are tied to membership activity, the quorum value may be determined based on the sum of all membership status values. Thus, for example, if 100 members have a total of 100 membership status value credits when all members are active (e.g., one point for each active member), but after some time the total membership status value reduces to 80, 64 membership status value credits may be required to be enabling for an 80% presence requirement to be met.

In some cases, it may be desirable to purge membership ranks of inactive members. Thus, some example embodiments may enable a smaller quorum (e.g., 10% of the active votes or full membership status value) to call for a notification to require re-registration of members for membership status to be maintained. Moreover, the notification may be sent through channels other than the normal group communication channels (or in addition to such channels) to have a greater likelihood of reaching passive or inactive members. Those members that re-register may maintain their membership status (in some cases with a restored membership status value), while those that do not re-register within a predetermined time period may have their membership status revoked.

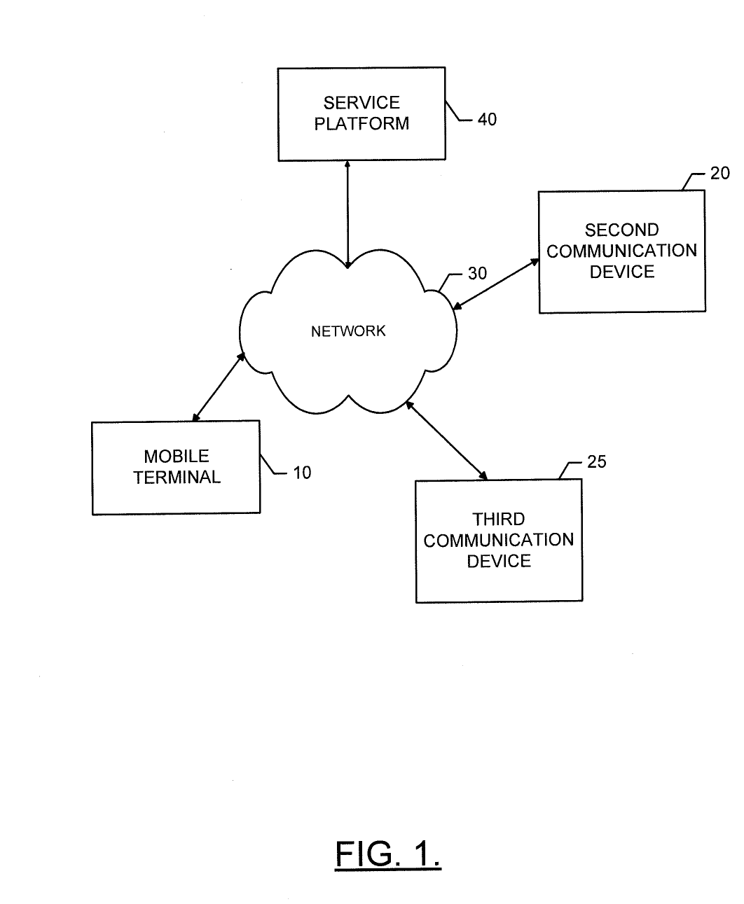

FIG. 1 illustrates a generic system diagram in which a device such as a mobile terminal 10, which may benefit from embodiments of the present invention, is shown in an exemplary communication environment. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more network devices such as a service platform 40 with which the mobile terminal 10 (and possibly also the second communication device 20) may communicate to provide, request and/or receive information. Furthermore, in some cases, the mobile terminal 10 may be in communication with the second communication device 20 (e.g., a PC or another mobile terminal) and one or more additional communication devices (e.g., third communication device 25), which may also be either mobile or fixed communication devices.

The mobile terminal 10 may be any of multiple types of mobile communication and/or computing devices such as, for example, portable digital assistants (PDAs), pagers, mobile televisions, mobile telephones, gaming devices, laptop computers, cameras, camera phones, video recorders, audio/video player, radio, global positioning system (GPS) devices, ebook devices, or any combination of the aforementioned, and other types of voice and text communications devices, can readily employ embodiments of the present invention. The second and third communication devices 20 and 25 may be any of the above listed mobile communication devices or an example of a fixed communication device such as a PC or other computing device or communication terminal having a relatively fixed location and wired or wireless access to the network 30.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. Alternatively, such devices may include communication interfaces supporting landline based or wired communication with the network 30. In turn, other devices such as processing elements (e.g., personal computers, server computers or the like) may be coupled to the mobile terminal 10 and/or the second and third communication devices 20 and 25 via the network 30. By directly or indirectly connecting the mobile terminal 10 and/or the second communication device 20 and other devices to the network 30, the mobile terminal 10 and/or the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, the first communication device (e.g., the mobile terminal 10) may be a mobile communication device such as, for example, a personal digital assistant (PDA), wireless telephone, mobile computing device, camera, video recorder, audio/video player, positioning device, game device, television device, radio device, ebook device, or various other like device or combinations thereof. The second and third communication devices 20 and 25 may be mobile or fixed communication devices. Regardless of the form of instantiation of the devices involved, embodiments of the present invention may relate to the provision of access to content within a defined group of users and/or the devices of the users. The group may be predefined based on any of a number of ways that a particular group may be formed. In this regard, for example, invited members may accept invitations to join the group, applications may be submitted and accepted applicants may become group members, or a group membership manager may define a set of users to be members of a group. Thus, for example, group members could be part of a social network or may be associated with a particular service such as a service hosted by or associated with the service platform 40. Accordingly, it should be appreciated that, although FIG. 1 shows three example devices capable of communication, some embodiments may include groups like social networks with the potential for many more group members and corresponding devices. Thus, FIG. 1 should not be seen as being limiting in this regard.

In an example embodiment, the service platform 40 may be a device or node such as a server or other processing circuitry. The service platform 40 may have any number of functions or associations with various services. As such, for example, the service platform 40 may be a platform such as a dedicated server, backend server, or server bank associated with a particular information source, function or service. As such, the service platform 40 may represent one or more of a plurality of different services or information sources. The functionality of the service platform 40 may be provided by hardware and/or software components configured to operate in accordance with known techniques for the provision of information to users of communication devices, except as modified as described herein.

In an exemplary embodiment, the service platform 40 may provide, among other things, content management, content sharing, content acquisition and other services related to communication and media content. Nokia's Ovi suite is an example of a service provision mechanism that may be associated with the service platform 40. In some cases, the service platform 40 may include, be associated with, or otherwise be functional in connection with a content distributor 42. However, the content distributor 42 could alternatively be embodied at one or more of the mobile terminal 10 and/or the second and third communication devices 20 and 25. As such, for example, in some cases the network 30 could be an ad hoc, peer-to-peer (P2P) network in which the content distributor 42 is embodied in at least one of the devices forming the P2P network. In any case, as will be discussed in greater detail below, the content distributor 42 may manage the ability of group content to be accessed based on presence information related to members of the group or based on membership status values of current participants or voters relative to the sum of membership status values for the group. In this context, group content may be content that is stored with restrictions regarding access to the content. Moreover, the restrictions may be associated with membership in the group and the presence of group members. In some cases, the group content may be stored collectively on one or more of the devices that are associated with group members. However, in other cases, the group content may be stored in a central location or otherwise in a location accessible and manageable by the content distributor 42. Thus, for example, the group content may be stored at the service platform 40. As such, in some embodiments the service platform 40 (or another device hosting the content distributor 42) may provide functionality associated with enabling access to group content based on presence information regarding members of the group.

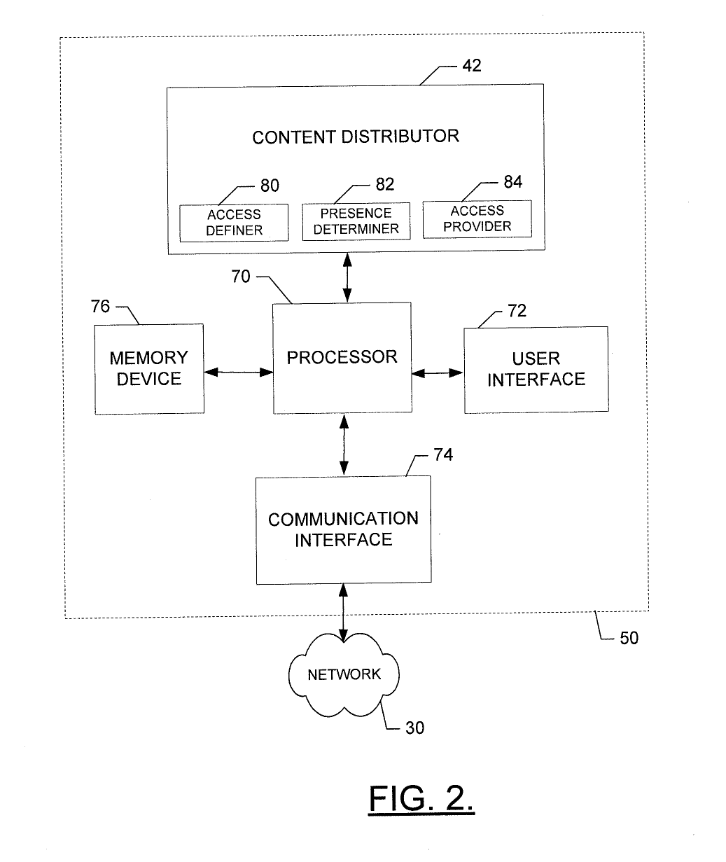

FIG. 2 illustrates a schematic block diagram of an apparatus for enabling the provision of access to social content based on membership activity according to an example embodiment of the present invention. An exemplary embodiment of the invention will now be described with reference to FIG. 2, in which certain elements of an apparatus 50 for providing access to social content based on membership activity are displayed. The apparatus 50 of FIG. 2 may be employed, for example, on a communication device (e.g., the mobile terminal 10 and/or the second or third communication devices 20 or 25) or a variety of other devices, both mobile and fixed (such as, for example, any of the devices listed above). Alternatively, embodiments may be employed on a combination of devices. Accordingly, some embodiments of the present invention may be embodied wholly at a single device (e.g., the mobile terminal 10) or by devices in a client/server relationship. Furthermore, it should be noted that the devices or elements described below may not be mandatory and thus some may be omitted in certain embodiments.

Referring now to FIG. 2, an apparatus 50 for providing access to social content based on membership activity is provided. The apparatus 50 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates or other structure configured to store data (e.g., bits) that may be retrievable by a machine (e.g., a computing device). The memory device 76 may be configured to store information, data, applications, instructions or the like for enabling the apparatus to carry out various functions in accordance with example embodiments of the present invention. For example, the memory device 76 could be configured to buffer input data for processing by the processor 70. Additionally or alternatively, the memory device 76 could be configured to store instructions for execution by the processor 70. In some embodiments, the memory device 76 may also or alternatively store content items (e.g., media content, documents, chat content, message data, videos, music, pictures and/or the like) comprising group content.

The apparatus 50 may, in some embodiments, be the service platform 40 (or a component device thereof), the mobile terminal 10 or other computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied in hardware as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), central processing unit (CPU), a hardware accelerator, a vector processor, a graphics processing unit (GPU), a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or other content sharing device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an example embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control the content distributor 42. In some cases, the content distributor 42 may include or control a group definer 80, a presence determiner 82, and an access provider 84. However, in other embodiments, the content distributor 42 may merely be in communication with the group definer 80, the presence determiner 82 and the access provider 84, and the group definer 80, the presence determiner 82 and the access provider 84 may each be controlled or embodied by the processor 70. The content distributor 42, the group definer 80, the presence determiner 82 and the access provider 84 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the content distributor 42, the group definer 80, the presence determiner 82 and the access provider 84, respectively, as described below. Thus, in examples in which software is employed, a device or circuitry (e.g., the processor 70 in one example) executing the software forms the structure associated with such means.

In an example embodiment, the content distributor 42 may be configured to manage the provision of access to the group content associated with a particular group. In order to manage group content, the content distributor 42 may initially receive information defining the members of the group and defining the content to be protected (e.g., the group content). In some cases, the content distributor 42 may also be configured to provide tools or functionality to enable group definition. However, in alternative embodiments another entity (e.g., the group definer 80) may be configured to define the group, and the content distributor 42 may be enabled to receive information from the group definer to define the members of the group. As indicated above, the members of the group may be invitees, applicants, designees, or may otherwise be made members of the group by any suitable mechanism.

In some cases, the group definer 80 may be utilized by a particular user (e.g., a user of the mobile terminal 10 or the first or second communication device 20 or 25) to establish the group. As an example, the user may implement the group definer 80 to identify a list of identities of other users to be added to or invited to be added to the group. The list of identities may be manually entered, or may be selected from a contact list or address book of the user. Alternatively, the user may define specific criteria or characteristics of other users that are desirable for group membership. The group definer 80 may then examine information pertaining to a plurality of contacts or users associated with a service or an address book and provide invitations to or otherwise designate users that fit the specific criteria or characteristics as group members. After invited members accept membership or are otherwise accepted as members of the group, the group definer 80 may maintain a record of members (e.g., by a list of identities of each respective member in a member list).

The group definer 80 may also be configured to enable one or more group members to define access policies for application by the access provider 84 as described in greater detail below. In this regard, for example, for content items designated as group content, the access provider 84 may apply access policies to determine whether to grant access to the corresponding group content. The group definer 80 may be used, either initially upon creation of the group, or during operation of the group, to define the policies to govern access to the group content. The policies themselves may range from simple to elaborate, but in an example embodiment may include at least a presence threshold or membership status value threshold. The presence threshold or membership status value threshold may be a minimum number of group members required to be present or required to express agreement with a proposition in order to enable access to group content by present members or in order to approve or enable certain group related functionalities. Thus, for example, after a group is defined to include three members (e.g., a user of the mobile terminal 10, a user of the second communication device 20 and a user of the third communication device 25) via the group definer 80, the group definer 80 may be further utilized to define a presence threshold providing the minimum number of group members (e.g., two or even all three) that are to be present in order to permit any group member to access the group content or to permit changes to group content access policies or initiate other group related functions.

In response to at least two group members being online or otherwise present at any given time, a session may be in progress. However, a group session with enablement for access by group members to group content may only be enabled in response to the simultaneous presence of a number of members sufficient to meet the presence threshold. In some embodiments, the group definer 80 may also be utilized to define who, if anyone, may make modifications to the access policies. As such, if access policy modifications are permitted, the presence threshold may be changed. In some cases, a sufficient number of members may be required to approve of policy changes. Accordingly, there need not necessarily be a group administrator since, in some embodiments, no one member alone may modify access policies or even group membership after group creation.

In an example embodiment, the content distributor 42 may reserve a portion of the memory device 76 (or another accessible storage medium) for storage of group content. The group content may be pre-existing content stored in association with the creation of the group. However, the group content may also be supplemented over time with additional submissions of content items either made by the members of the group or otherwise made available for group consumption. As yet another alternative, the group content may include the storage of transaction information, communication threads, content, or other media that may be created during an active group communication session. Combinations of the above mechanisms for creating group content, some of which may also include other types of content, may also be utilized for creation of the group content. The group content may include content items stored in folders, storage locations, web pages or other content sources capable of providing the group content to authorized members. Once the group content is stored or otherwise identified, the access provider 84 may take over the provision of access to the group content based on presence information related to the members of the group. In some cases, personal copies of group content may be prohibited. As such, group content may be “read only” content. However, in other cases, some content (e.g., content provided from the personal holdings of a group member) may be permitted to be duplicated by the person submitting such content originally. Some content may also be permitted to be copied by others under predefined and specific circumstances. Policies regarding specific content may be determined by the group on an individual basis or based on predefined group rules or agreed upon preferences.

The presence information utilized by the access provider 84 to determine whether to grant access to group content may be related to physical presence (e.g., group members being in the same or nearly the same physical location simultaneously) or virtual presence (e.g., potentially remotely located group members being present online at the same time). Thus, for example, in response to members that are physically remote from each other being each logged into the service platform 40 in association with a particular service (e.g., the Ovi suite), being in a particular chat room, having joined a particular P2P network, or being otherwise constructively “present” at the same time as other group members, the content distributor 42 may be configured to make access determinations with regard to the group content. Accordingly, in some embodiments, the access provider 84 may include a presence determiner 82.

The presence determiner 82 may be configured to track presence information for group members. As such, for example, the presence determiner 82 may monitor which group members log into or are otherwise online with respect to a service, network or application (e.g., a web application accessible via the Internet) associated with the group. In some cases, the presence determiner 82 may review position information for group members to determine whether the presence threshold is met for group members in a specific location. In yet other cases, such as cases in which a short range communication method is employed (e.g., Bluetooth), the presence determiner 82 may perform a scan of the environment to determine which and how many members are proximately located with respect to each other in order to determine whether the presence threshold is met. In still other situations, a telephone number (e.g., a conference call number) may be provided for members to call in and those that call in may be counted as being present. Accordingly, regardless of the method by which presence information is determined, the presence determiner 82 may be enabled to determine presence information defining the number of group members that are currently or simultaneously present. Presence information determined by the presence determiner 82 may be communicated to the content distributor 42 (in some cases via the access provider 84).

As indicated above, in situations where active participation in group activities varies, a static presence threshold and in some cases also a static or unitary value associated with the presence of all individuals may not be appropriate. Accordingly, the presence determiner 82 may be configured to apply dynamic adjustments to consider varying participation among group members in relation to determining the presence threshold and ultimately in relation to determining what group related activities are to be enabled based on the group members currently present (or voting).

In this regard, for example, the presence determiner 82 may be configured to define modifications to be made to the presence threshold (maintained by the group definer 80) to define a dynamic “quorum” value that is determinable periodically (or at each group related event where a determination of group presence relative to the presence threshold is made). In some cases, the presence determiner 82 may be configured to determine the quorum value itself, or provide information to the group definer 80 to enable the group definer 80 to determine the quorum value. The quorum value may be determined as a predetermined number of active group members. As such, the quorum value may be a dynamic value that is determinable based on an assessment of recent membership activity. In an example embodiment, the presence determiner 82 may be configured to assign a membership status of either active or inactive (or passive) to each member (e.g., of the member list in the group definer 80). The membership status may be determined by the presence determiner 82 based on an assessment of recent membership activity. Active members may be considered as members that have actively participated in group activity within a predetermined period of time (e.g., one day, three days, one week, one month, etc.). The qualifying group activity may simply be a log in activity or other activity such as posting content, commenting on content, sending a message, and/or the like. After the number of active members (as opposed to the total number of members) has been determined, the quorum value may be calculated based on the number of active members rather than being based on the total number of members. Thus, as another example, if 50% presence is required for group decision making or access to the group content, and 40 members are included in the group. If only 18 members are active members, then the presence of 9 members (rather than 20) would be required to enable a group decision to be passed or group access to be granted. Of note, without this modification, it would be impossible for the 18 active members, even if all of them were routinely present together, to ever access the group content without somehow coaxing at least two inactive members to join them.

In some cases, in addition to or as an alternative to the dynamic quorum value calculation, membership status may not be binary in terms of being either active or passive exclusively, but instead varying levels of degree may be associated with the activity of each member. In such an example, decaying voting rights or decaying membership status values may be applied to the members. In an example embodiment, the presence determiner 82 may be configured to again note the activity of each member of the member list relative to some predetermined time period (e.g., in terms of days, weeks, months, etc.) forming an activity reporting period. Each member may start out with a full membership status value (e.g., having a value of 1 or some other predetermined value). Thereafter, any qualifying group activity (e.g., a log in, posting a comment, posting content, sending a message, etc.) within the activity reporting period may result in the full membership status value being maintained for the corresponding member. However, if a member does not participate in any qualifying group activity over the activity reporting period, the membership status value assigned to the member may be decreased by a predetermined value. The predetermined value for reduction of the membership status value may be a set value (e.g., 0.1) for each activity reporting period during which no qualifying group activity is noticed by the presence determiner 82, or may increase as the number of sequential activity reporting periods without activity increases.

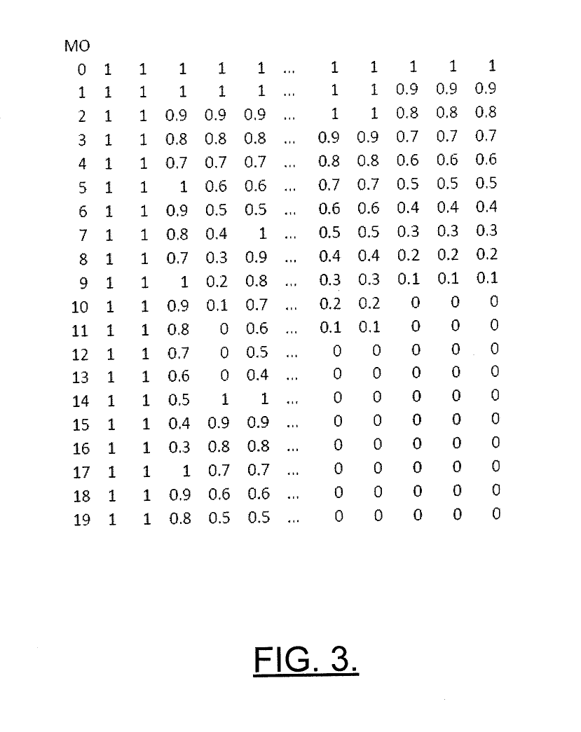

FIG. 3 illustrates a table showing an example in which a predetermined value is decremented from the membership status value of a plurality of members over a period of 19 months where one month is the activity reporting period. The table of FIG. 3 illustrates only the first five and last five members tracked over the 19 month reporting period, but it should be evident that the table could be applied over any number of group members. Moreover, in some embodiments, the table itself may not actually be used, but corresponding values (e.g., those shown in the table for each respective member at a given time) may be assigned to the identity of each member in the member list of the group definer 80. However, in other embodiments, a table similar to that of FIG. 3 could be maintained.

As shown in FIG. 3, at month 0, after all members have registered, the membership status value of each member may be set to 1. After one month, all but the last three members in the second group of five members have logged in and those members that have not logged in therefore have their membership status values reduced by 0.1 each. After two months three more members have not logged in (the last three in the first group of five) and the three members that did not log in the previous month have also not logged in again. Each of the members that did not log in during the second month have their corresponding membership status values decrease by 0.1 so that those that have missed one month have membership status values of 0.9 and those that have missed two months have membership status values of 0.8. This continual updating of membership status values continues for all members each month. If a member logs in after a period of inactivity (even over several months), the member's membership status value is reset to 1.

For any given period of time, the total membership status value of the group (or group membership status value) may be the sum of each member's membership status value. Adjustments to the quorum value may be made based on the changes to the group membership status value. Thus, for example, for a 20 member group where the last three members do not log in after one month (as shown in FIG. 3), the original group membership status value may be 20. However, the group membership status value after the first month may be reduced to 19.7. After the second month, where three more members have not participated in group activities in addition to the same three that did not participate the prior month, the group membership status value may be reduced by an additional 0.6 (0.1 for each of the 6 inactive members for that month) to 19.1. The quorum value may then be determined for each month (or other activity reporting period) based on the group membership status value for the corresponding month. Thus, for example, the original quorum value, if a 50% presence threshold is required, may be 10. However, the quorum value may decrease to about 9.9 (19.7 times 50%) after the first month, and decrease to 9.6 after the second month (19.1 times 50%).

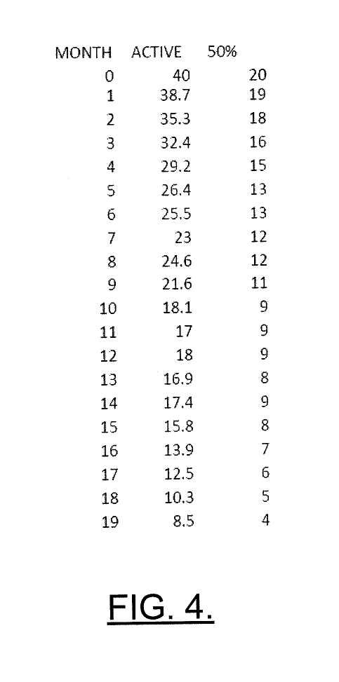

In some cases, even after the quorum value is calculated (which value need not necessarily be a whole number) the number of individuals required to reach a quorum may be rounded to the nearest whole number. For example, FIG. 4 illustrates a sample series of active members (expressed in terms of a group membership status value for a 40 person group) and a corresponding number of members required to exceed the quorum value for each respective period (given a 50% presence threshold). In this example, the members present may be given a full value relative to the number of members required to exceed the quorum value regardless of each members personal membership status value immediately prior to the member's logging in.

Some might consider that certain aspects of the examples described above could erode democracy within the group, since the quorum value may decrease to the point where a few active people may dominate or have greater say within a large group (e.g., due to reduction in quorum value as active participation decreases). To avoid this effect, some embodiments may enable purging of membership ranks to cut the membership rolls to only those members that affirmatively elect to continue membership in the group. In an example embodiment, the decision to purge may be proposed by any group member, and passed in response to a predetermined number of members voting for the purge. In some cases, a relatively small group of members may only be required to institute a purge (e.g., a value less than the quorum value such as, for example, 10%).

To conduct a purge, the group definer 80 may be employed to send a high priority message to all members of the group (e.g., both active and passive members). The message may be sent in one or more formats and, in some cases, may be required to be sent by a channel other than that over which normal group messages are sent since passive members may clearly not be responsive to the normal group message channels. Members may have a limited time period (e.g., a week or month) to respond to the message to affirm their membership. However, if they are not heard from in the limited time period, the membership may be canceled. Those members that respond to the message may be re-registered as members and in some cases their corresponding membership status values may be fully restored.

The access provider 84 may apply the access policies in order to compare the current situation to the access policies to determine whether to grant access to the group content. As such, for example, the access provider 84 may receive presence information from the presence determiner 82 and determine whether the quorum value is met based on the number of group members present (e.g., physically or virtually).

In response to the quorum value being met, the access provider 84 may enable access to all of the group content or enable other group functionality to be accessed. As such, in some embodiments, all group content may be subject to a single set of globally applicable access policies so that, for example, if a quorum of group members is present (e.g., the number of group members present exceeds the presence threshold), then all group content is made available to the group members. However, if the number of group members is less than the presence threshold, then group content access is not granted.

As an alternative to the application of globally applicable access policies, content specific access policies may be applied. In this regard, for example, some content may have different access policies applicable thereto than other content. When content is initially stored as group content, the content may (e.g., by user preference or group preference) have specific requirements for presence criteria before access to such content may be enabled. For example, some content may have relatively low restrictions associated therewith such that a relatively low presence threshold may be met in order to enable access to such content (e.g., just a few members). However, other content may have relatively high restrictions associated therewith such that a relatively high presence threshold may be met in order to enable access to such content (e.g., a majority or even all of the members). In any case, the access provider 84 may manage the provision of access to group members based on presence information.

In some cases, an authentication code may be associated with the granting of access to the group content. However, the authentication code may be distributed amongst the group members and authentication of the group may be accomplished based on the aggregation of distributed portions of the authentication code. Accordingly, each group member may only be capable of providing his or her own respective portion of the authentication code. In such a scenario, the access provider 84 may be configured to accept portions of the authentication code from each respective member of the group and compile or otherwise combine the portions to determine whether the compiled or otherwise combined portions of the authentication code are sufficient to authenticate the group and enable access to the group content. The authentication code (or at least the portions thereof) may therefore correspond to the presence information for each respective member. Moreover, the authentication code may not need to be presented in full in order to enable access to the group content. Thus, for example, in situations where a session is attempted with less than all of the group members, the group members may be enabled to access the group content if an acceptable threshold portion of the authentication code is provided. As such, the acceptable threshold portion of the authentication code may correspond directly to the presence threshold. Accordingly, for example, if an 80% presence threshold were set such that on average four out of every five group members are required to be present in order to enable access to the group content, then if 80% of the authentication code could be aggregated based on the members present, the acceptable threshold portion of the authentication code may be met and access to the group content may be provided. The presence threshold in this example embodiment may also be subject to modification based on quorum value calculation as described above.

Once access is permitted to group content, the members of the group may thereafter be enabled to access the group content. Moreover, content may be distributed, created, modified, shared, experienced or otherwise handled by group members after access is granted. Activities associated with the handling of group content may be managed or controlled by the content distributor 42. Accordingly, embodiments of the present invention may provide a set of data or content items (e.g., the group content) that are permissibly accessed only when all or a predefined number or percentage of group members are present. Thus, for example, the group content may not be manipulated or handled without all or the predefined number or percentage of group members (at least meeting the quorum value) knowing about the manipulation or handling. Example situations in which this may be useful may include groups working with copyrighted content creation, handling of confidential or secret data, decision making forums or working groups, groups of friends or acquaintances. Thus, for example, embodiments may be employed in the context of providing and managing group licenses for materials such as copyrighted content like music, books or movies. Moreover, in some cases, the groups may be trying to avoid certain situations such as gossip or harmful misuse of information by requiring a quorum of members to be present before a session may be effectively undertaken with respect to group content.

In an example embodiment, multiple presence thresholds may be employed with corresponding different levels of access being associated with each respective presence threshold. In some cases, the presence thresholds may correspond to presence of respective different percentages of the total group membership. Thus, for example, if a relatively low or minimum threshold percentage of group members are present, a relatively low level of access may be granted. As each respective higher threshold percentage of group members is met, corresponding greater levels of access may be granted until, at a highest threshold percentage, full access is granted. As an example, if between 10% and 30% of group members are present, read only access may be provided for group content. However, if group membership presence falls between 30% and 70%, write access may additionally be enabled. Meanwhile, if 70% of group members are present, full access to read, write, modify, share, download, etc., may be granted. Other assignments with respect to the value and number of thresholds and corresponding levels of access granted may also be provided. These access level based presence values may also be subject to modification based on the quorum value modifications described above.

The content distributor 42 may be configured to enable user interface for group members with respect to accessible content. As such, the content distributor 42 may be responsible for providing automatically appearing inputs (e.g., soft keys or other software defined functional interface mechanisms) to be shown on respective member device displays to indicate either that access rights are granted or that specific available interface options or functions are enabled with respect to accessible content. Thus, for example, options for sharing content, selecting specific views of content, chatting with online members, opening audio links, initiating a call, playing a video, or other commands may be presented to group members according to the applicability of such commands for the content and/or members to which such options pertain. In some cases, devices may be manufactured with specific keys for supporting functionality associated with embodiments of the present invention.

As indicated above, one potential embodiment may be employed in connection with the provision and management of group licenses (e.g., for copyrighted content like music, movies, ebooks, games, pay television channels, etc.). In connection with these example embodiments, a group license may be a license to use content among group members (e.g., service users) by either one at a time or many at a time. In this regard, if employed in connection with a service associated with the service platform 40, the service platform 40 may control access to the content and how long such access is granted. Group licenses may therefore be used to control content use or moving/copying content between devices. A group license may also be used to control simultaneous content consumption among group members (e.g., service users) by controlling content activation for simultaneous consumption by multiple members of the group. Thus, for example, media consumption may be enhanced by knowing that your friend or friends are doing the same thing at the same time, thereby enhancing the social aspect of being part of the group. Additionally, one or more group members may act as the content director (or disk jockey) for providing content for other group members to experience together. Moreover, this role may be shared or rotated amongst different members of the group. The concept of a group license may also enable social purchasing. In other words, a group of users may pool resources to buy content that no individual one of them could afford to buy. For example, teenagers, individuals in developing countries, communities, clubs or other groups with common interests may keep costs down by purchasing one licensed copy for the group. If an embodiment of the present invention is provided in connection with a service associated with the service platform 40, the service platform 40 may provide or have access to an online store that may include various types of content and titles within each type to give group members the ability to select and purchase or otherwise acquire desirable content for group usage. In some cases, the service platform 40 (e.g., via the content distributor 42) may control the number of copies of content that may be used on a device at any given time. For example, some content may be licensed for a predetermined number of simultaneous users at any given time.

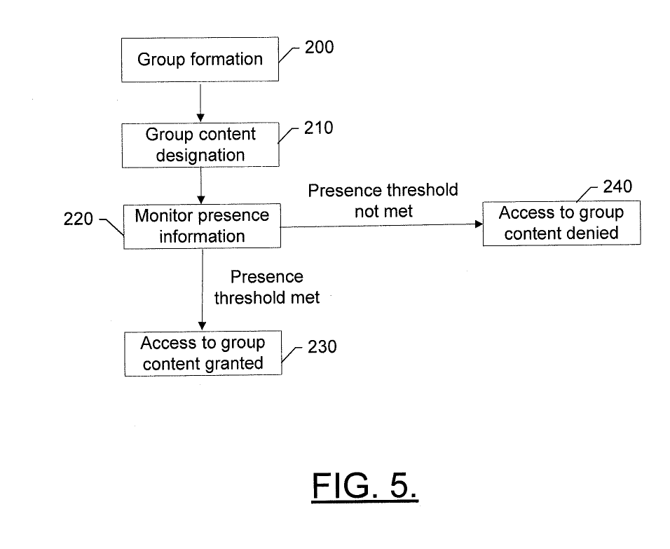

FIG. 5 illustrates a block diagram pertaining to activities associated with group formation and operation according to an exemplary embodiment. In this regard, at operation 200 a group may be formed. Group content may be designated at operation 210. During group formation and/or when group content is designated, access policies may be defined for the group content. At operation 220, presence information may be monitored. If the presence threshold is met, a group session may be initiated and access to the group content may be provided at operation 230. If the presence threshold is not met, access to group content may be denied at operation 240. As indicated previously, the presence threshold may be modified to generate a quorum value based on active membership considered in either a binary fashion or in a decaying fashion as described in greater detail above.

Accordingly, some embodiments of the present invention provide for the management of access to group content based on presence information associated with the activity of members of the group. As a result, group members may be enabled to flexibly manage group costs and resources in relation to distributing content within the group.

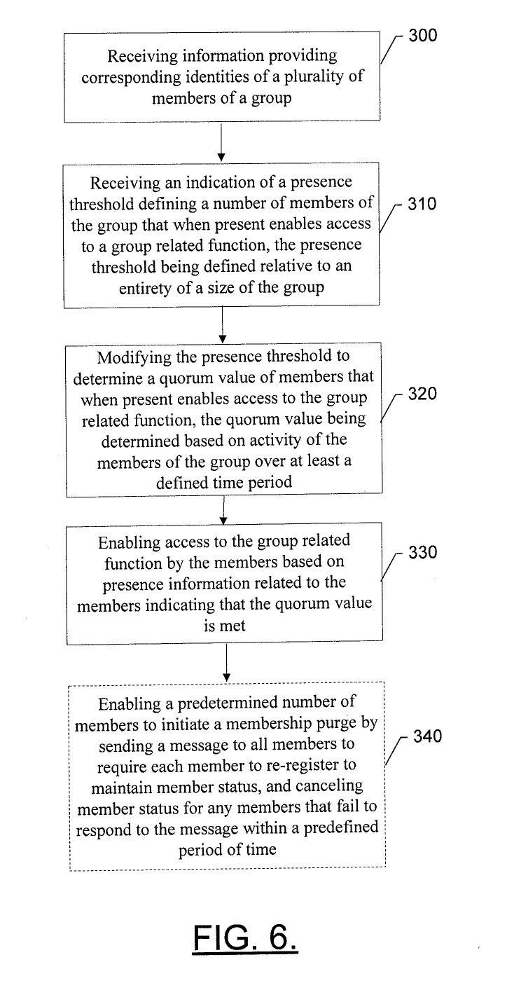

FIG. 6 is a flowchart of a method and program product according to example embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture including instruction means which implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions, combinations of operations for performing the specified functions and program instructions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 6, may include receiving information providing corresponding identities of a plurality of members of a group at operation 300 and receiving an indication of a presence threshold defining a number of members of the group that when present enables access to a group related function at operation 310. The presence threshold may be defined relative to an entirety of a size of the group. The method may further include modifying the presence threshold to determine a quorum value of members that when present enables access to the group related function where the quorum value is determined based on activity of the members of the group over at least a defined time period at operation 320, and enabling access to the group related function by the members based on presence information related to the members indicating that the quorum value is met at operation 330.

In some embodiments, certain ones of the operations above may be modified or further amplified as described below. Moreover, in some situations, the operations described above may be augmented with additional optional operations (an example of which is shown in FIG. 6 in dashed lines). It should be appreciated that each of the modifications, augmentations or amplifications below may be included with the operations above either alone or in combination with any others among the features described herein. In an example embodiment, the method may further include enabling a predetermined number of members to initiate a membership purge at operation 340. In some cases, initiating the membership purge may include sending a message to all members to require each member to re-register to maintain member status, and canceling member status for any members that fail to respond to the message within a predefined period of time. In some cases, sending the message may include sending the message over at least one communication channel that is different than communication channels used for routine group activity. In an example embodiment, enabling access to the group related function may include enabling access to group content including at least one content item stored in association with the group. In some embodiments, modifying the presence threshold to determine the quorum value may include dividing the members into an active segment and an inactive segment based on activity of the members over the defined time period and determining the quorum value relative to only the active segment. In an example embodiment, modifying the presence threshold to determine the quorum value may include assigning all of the members an initial membership status value, decrementing the membership status value of members that are inactive over the defined period of time, and determining the quorum value relative to a sum of all membership status values of the members. In some embodiments, modifying the presence threshold to determine the quorum value may include assigning all of the members an initial membership status value, decrementing the membership status value of each member that is currently inactive by a predetermined amount for each consecutive period of inactivity, and determining the quorum value relative to a sum of all membership status values of the members.

In an example embodiment, an apparatus for performing the method of FIG. 6 above may comprise a processor (e.g., the processor 70) configured to perform some or each of the operations (300-340) described above. The processor may, for example, be configured to perform the operations (300-340) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-340 may comprise, for example, the processor 70, or respective ones of the content distributor 42, the group definer 80, the presence determiner 82, the access provider 84, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the at least one processor, cause the apparatus at least to perform:
receiving information providing corresponding identities of a plurality of members of a group;
receiving an indication of a presence threshold defining a number of members of the group that when present enables access to a group related function, the presence threshold being defined relative to an entirety of a size of the group;
modifying the presence threshold to determine a quorum value of members that when present enables access to the group related function, the quorum value being determined based on activity of the members of the group over at least a defined time period; and
enabling access to the group related function by the members based on presence information related to the members indicating that the quorum value is met.

2. The apparatus of claim 1, wherein the at least one memory and the computer program code are further configured to, with the at least one processor, cause the apparatus to enable access to the group related function by enabling access to group content including at least one content item stored in association with the group.

3. The apparatus of claim 1, wherein the at least one memory and the computer program code are further configured to, with the at least one processor, cause the apparatus to modify the presence threshold to determine the quorum value by dividing the members into an active segment and an inactive segment based on activity of the members over the defined time period and determining the quorum value relative to only the active segment.

4. The apparatus of claim 1, wherein the at least one memory and the computer program code are further configured to, with the at least one processor, cause the apparatus to modify the presence threshold to determine the quorum value by:
assigning all of the members an initial membership status value;
decrementing the membership status value of members that are inactive over the defined period of time; and
determining the quorum value relative to a sum of all membership status values of the members.

5. The apparatus of claim 1, wherein the at least one memory and the computer program code are further configured to, with the at least one processor, cause the apparatus to modify the presence threshold to determine the quorum value by:
assigning all of the members an initial membership status value;
decrementing the membership status value of each member that is currently inactive by a predetermined amount for each consecutive period of inactivity; and
determining the quorum value relative to a sum of all membership status values of the members.

6. The apparatus of claim 1, wherein the at least one memory and the computer program code are further configured to, with the at least one processor, cause the apparatus to enable a predetermined number of members to initiate a membership purge comprising:
sending a message to all members to require each member to re-register to maintain member status; and
canceling member status for any members that fail to respond to the message within a predefined period of time.

7. The apparatus of claim 6, wherein the at least one memory and the computer program code are further configured to, with the at least one processor, cause the apparatus to send the message by sending the message over at least one communication channel that is different than communication channels used for routine group activity.

8. A method comprising:
receiving information providing corresponding identities of a plurality of members of a group;
receiving an indication of a presence threshold defining a number of members of the group that when present enables access to a group related function, the presence threshold being defined relative to an entirety of a size of the group;
modifying the presence threshold to determine a quorum value of members that when present enables access to the group related function, the quorum value being determined based on activity of the members of the group over at least a defined time period; and
enabling access to the group related function by the members based on presence information related to the members indicating that the quorum value is met.

9. The method of claim 8, wherein enabling access to the group related function comprises enabling access to group content including at least one content item stored in association with the group.

10. The method of claim 8, wherein modifying the presence threshold to determine the quorum value comprises dividing the members into an active segment and an inactive segment based on activity of the members over the defined time period and determining the quorum value relative to only the active segment.

11. The method of claim 8, wherein modifying the presence threshold to determine the quorum value comprises:
assigning all of the members an initial membership status value;
decrementing the membership status value of members that are inactive over the defined period of time; and
determining the quorum value relative to a sum of all membership status values of the members.

12. The method of claim 8, wherein modifying the presence threshold to determine the quorum value comprises:
assigning all of the members an initial membership status value;
decrementing the membership status value of each member that is currently inactive by a predetermined amount for each consecutive period of inactivity; and
determining the quorum value relative to a sum of all membership status values of the members.

13. The method of claim 8, further comprising enabling a predetermined number of members to initiate a membership purge comprising:
sending a message to all members to require each member to re-register to maintain member status; and
canceling member status for any members that fail to respond to the message within a predefined period of time.

14. The method of claim 13, wherein sending the message comprises sending the message over at least one communication channel that is different than communication channels used for routine group activity.

15. A computer program product comprising at least one computer-readable storage medium bearing computer program code embodied therein for use with a computer, the computer program code comprising code for:
receiving information providing corresponding identities of a plurality of members of a group;
receiving an indication of a presence threshold defining a number of members of the group that when present enables access to a group related function, the presence threshold being defined relative to an entirety of a size of the group;
modifying the presence threshold to determine a quorum value of members that when present enables access to the group related function, the quorum value being determined based on activity of the members of the group over at least a defined time period; and
enabling access to the group related function by the members based on presence information related to the members indicating that the quorum value is met.

16. The computer program product of claim 15, wherein code for enabling access to the group related function includes instructions for enabling access to group content including at least one content item stored in association with the group.

17. The computer program product of claim 15, wherein code for modifying the presence threshold to determine the quorum value includes instructions for dividing the members into an active segment and an inactive segment based on activity of the members over the defined time period and determining the quorum value relative to only the active segment.

18. The computer program product of claim 15, wherein code for modifying the presence threshold to determine the quorum value includes instructions for:
assigning all of the members an initial membership status value;
decrementing the membership status value of members that are inactive over the defined period of time; and
determining the quorum value relative to a sum of all membership status values of the members.

19. The computer program product of claim 15, wherein code for modifying the presence threshold to determine the quorum value includes instructions for:
assigning all of the members an initial membership status value;
decrementing the membership status value of each member that is currently inactive by a predetermined amount for each consecutive period of inactivity; and
determining the quorum value relative to a sum of all membership status values of the members.

20. The computer program product of claim 15, further comprising code for enabling a predetermined number of members to initiate a membership purge comprising:
sending a message to all members to require each member to re-register to maintain member status; and
canceling member status for any members that fail to respond to the message within a predefined period of time.
